(19) United States
(12) Patent Application Publication
(10) Pub. No.: US 2007/0102837 A1
(43) Pub. Date: May 10, 2007

(54) Tool having desired thermal management properties and a method for producing a tool having desired thermal management properties

(76) Inventors: Mark Manuel, Shelby Township, MI (US); Thomas N. Greaves, Rochester Hills, MI (US); Matthew T. Lowney, Davisburg, MI (US)

Correspondence Address: BROOKS KUSHMAN P.C., 1000 TOWN CENTER, TWENTY-SECOND FLOOR, SOUTHFIELD, MI, 48075, US

(21) Appl. No.: 11/233,708

(22) Filed: Sep. 23, 2005

(51) Int. Cl. E04B 1/16; B28B 13/02; B21B 1/46; F28F 7/00

(52) U.S. Cl. 264/35; 29/527.1; 425/447; 29/527.3; 165/185

(57) ABSTRACT

A tool, such as tools 10, 50, 100 having voids, such as voids 18, 20 which may be selectively and substantially filled with copper or some other conductive material, such as material 30, effective to allow heat to be dissipated from a tangible item formation surface, such as surfaces 14, 54, 104. Also, a methodology to produce such tools 10, 50, 100 is presented.

### GENERAL BACKGROUND

1. Field of the Invention

The present invention generally relates to a tool having desired thermal management properties and to a method for producing a tool having such desired thermal management properties and more particularly, by way of example and without limitation, to a tool which may be used to selectively create a tangible item in a highly efficient manner and which has desired thermal management properties, and to a method for creating such a tool.

2. Background of the Invention

A tool is a tangible entity which is used to selectively create a certain item, such as an automotive part or component. Typically, such a tool was created from a block of material by the use of a creation process which required the block of material to be machined and/or manually “worked” in a certain manner over a relatively long period of time. As used throughout this description, the term “tool” is to be construed in the broadest possible manner to refer to any tangible good or item which may be used to selectively produce another tangible item or good.

While the foregoing tool creation process did allow such a tool to be created, it was relatively inefficient and costly due to the relatively large amount of time and effort required to produce the tool, and was prone to error due to the number and complexity of the relatively high number of manual operations which are required in the overall tool creation process. Such an error further increases the overall production cost since it typically causes a partially formed tool to be discarded, thereby wasting the time, effort, and material used to create the discarded pre-tool and/or causes components to be manufactured and/or produced having undesirable characteristics (e.g., dimensions or other physical attributes or characteristics).

To alleviate some or all of the foregoing drawbacks, a lamination strategy has been employed under which an intangible model of the tool is first formed within a computer and then used to sequentially create physical or tangible sections which are selectively joined in a manner which allows the joined tangible sections to form the desired tool. The sections may be configured in a manner which accounts for the various physical characteristics of previously created sections, in order to allow the overall formed tool to produce items having highly accurate dimensional characteristics and other features. Importantly, such a lamination strategy allows for the production of tools in a very cost effective and efficient manner while allowing for the production of items having very desirable and highly accurate characteristics and features.

While the foregoing strategies do allow for a tangible item to be formed in a highly efficient manner, they each require a thermal management strategy. That is, the respectively produced tools normally generate a certain amount of heat during item formation operation and in order to allow the formed items to continually and repeatedly have desired and accurate characteristics and to allow the tools to have a relatively long working life, the produced heat must be readily exported away from the respective creation surfaces or formation portions of the respective tools. The manner in which such exportation occurs is dependent upon the thermal strategy which is employed within these various tools.

Current thermal management strategies typically involve the selective transport of water within the produced tool and such water is typically in some sort of thermal contact with the tool production or item formation surface or portion of the tool, thereby receiving the produced heat and allowing for the produced heat to be dissipated from the item creation or formation surface or portion.

While water does allow for the desired dissipation of heat from the item creation or formation surface or portion, it does so in a relatively inefficient manner and, especially with respect to laminate type tools, sometimes undesirably leaks or emanates from the tools.

There is therefore a need for a tool which may be efficiently produced and which has enhanced thermal management properties which allow the tool to have a relatively long working life and to continually and consistently produce tangible items having desired characteristics and features. There is also a need for a new and improved method to efficiently create a tool having enhanced thermal management properties. The present invention addresses these needs in a new and novel manner and may be used to produce substantially any desired tangible item or good (including but not limited to tools) having substantially any sort of desired thermal management properties (e.g., cooling or heating).

### SUMMARY OF THE INVENTION

It is a first non-limiting object of the present invention to provide an item, such as a tool, which overcomes some or all of the previously delineated disadvantages of prior tools.

It is a second non-limiting object of the present invention to provide an item, such as a tool, which overcomes some or all of the previously delineated disadvantages of prior tools and which, by way of example and without limitation, includes enhanced thermal management characteristics.

It is a third non-limiting object of the present invention to provide a method for creating an item, such as a tool, which allows for the production of an item having enhanced thermal management features and characteristics.

According to a first non-limiting aspect of the present invention, an item is provided and includes at least one void which is substantially filled with a thermal management material and further includes a surface which is created from a second material which is dissimilar to the thermal management material.

According to a second non-limiting aspect of the present invention, a tool is provided and includes a body including a forming surface, wherein the forming surface is created from a first material and wherein the body is formed from the selective joinder of a first and a second sectional member and wherein the body includes at least one void which is substantially filled with a thermal management material; and a tube which traverses the body and which is at least partially bonded to the thermal management material residing within the body.

According to a third non-limiting aspect of the present invention, a method for making an item is provided and includes the steps of forming a pre-item having at least one void; and placing a thermal management material within the void, thereby forming the item.

These and other features, aspects, and advantages of the present invention will become apparent from a reading of the detailed description of the preferred embodiment of the invention, including the subjoined claims, and by reference to the following drawings.

### BRIEF DESCRIPTION OF THE DRAWINGS

FIG. 1 is a perspective and phantom view of a tool which is made in accordance with the teachings of the preferred, although non-limiting embodiment of the present invention.

FIG. 2 is a perspective and phantom view of a tool which is made in accordance with the teachings of a first alternate and non-limiting embodiment of the present invention.

FIG. 3 is a perspective and phantom view of a tool which is -made in accordance with the teachings of a second alternate and non-limiting embodiment of the present invention;

FIG. 4 is a partial side sectional view of a pre-tool being subjected to a first non-limiting tool creation methodology of the present invention.

FIG. 5 is a partial side sectional view of a pre-tool being subjected to a second non-limiting tool creation methodology of the present invention.

FIG. 6 is a partial side sectional view of a tool which is made in accordance with the teachings of a second alternate and non-limiting embodiment of the present invention.

FIG. 7 is a flow chart which comprises the tool formation methodology of the preferred embodiment of the invention.

FIG. 8 is a partial top assembled view of a pair of adjacent sectional members used to create a laminated tool having an internal passageway or void according to the teachings of the preferred embodiment of the invention.

### DETAILED DESCRIPTION OF THE PREFERRED EMBODIMENT OF THE INVENTION

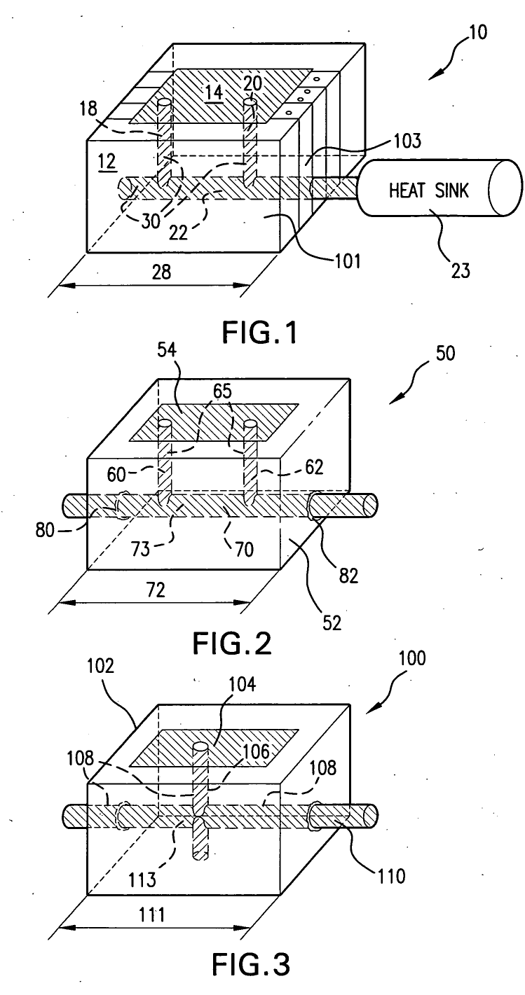

Referring now to FIG. 1, there is shown a tool 10. which is made in accordance with the teachings of the preferred, although non-limiting, embodiment of the invention.

Particularly, the tool 10 is formed from a first material 12 which may in a non-limiting manner comprise stainless steel, some other type of commercially available steel, or some composite material. Substantially any desired material may be used to form the tool 10. The tool 10 includes a tangible item formation surface 14 which may have substantially any desired geometric or spatial configuration which is required to selectively create or form a desired tangible item.

The tool 10 includes at least one (and in this non-limiting example which is shown in FIG. 1) has three internal voids or passageways 18, 20, 22. Particularly, the voids or passageways 18, 20 are communicatively coupled to the tangible item formation surface 14 and are further communicatively coupled, in the most preferred embodiment of the invention, to the void 22 which extends substantially along the entire width 28 of the tool 10.

In the most preferred embodiment of the invention, each of the voids or passageways 18, 20, 22 are substantially filled with copper material 30 or some other material which is adapted to efficiently transfer heat. In this manner, the heat which is generated at the tangible item formation surface 14 is communicated to the material 30 residing within the void 22 by the use of the material 30 which respectively resides within the voids 18, 20, thereby allowing the tool 10 to have a relatively long working life and allowing the tool 10 to produce tangible items having a respective desired dimensional accuracy and overall desired characteristics and features. In another non-limiting embodiment of the invention, the material 30 which is resident within the void 22 is coupled to a water reservoir or another type of heat sink 23 (remote from the tool 10), thereby allowing the heat which is communicated to the material 30 which is resident within the void 22 to be communicated outside of or remote from the tool 10. It should be appreciated that a number of such material filled voids, such as voids 18, 20, 22 may be used within the tool 10 and that these voids cooperatively communicate heat from the tangible item formation surface 14 and in some although not all embodiments, such heat is communicated to some sort of external heat sink 23. It should further be appreciated, that the tool 10 may utilize “plugs” or voids which are isolated (not communicatively coupled to another void or plug) but which may be communicatively coupled to the tangible item formation surface 14. These isolated voids receive the heat from the surface 14 and absorb such heat, thereby allowing the tool 10 to have the foregoing desirable features.

Referring now to FIG. 2, there is shown a tool 50 which is made in accordance with yet another non-limiting embodiment of the invention. Particularly, the tool 50 is formed from a first material 52 which may comprise stainless steel or another commercially available material and includes a tangible item formation surface 54. In this non-limiting embodiment, the tool 50 includes a pair of voids 60, 62 which are communicatively coupled to the tangible item formation surface 54. Each of the voids 60, 62 are substantially filled with copper material 65 or some other heat transfer material. The tool 50 includes a tube 70 which is operatively disposed along substantially the entire width 72 of the tool 50 and may operatively contain water or some other heat transfer material 73. The tube 70 is communicatively and, in one non-limiting embodiment, physically coupled to the material 65 and the tube 70 may be fixedly attached within the tool 50 by the use of welded connections 80, 82 and may be communicatively coupled to a heat sink (e.g., a body of water), such as the heat sink 23, which is remote from and external to the tool 50. It should be appreciated that the heat which is generated from the tangible item formation surface 54 is communicated to the contained material 73 by the material 65 and transported away from the surface 54, thereby allowing the tool 50 to have a relatively long working life and to allow the formed tool 50 to consistently produce components or tangible items which have a consistently high degree of spatial accuracy and having overall desirable characteristics.

Referring now to FIG. 3, there is shown a tool 100 which is made in accordance with the teachings of yet another non-limiting embodiment of the invention.

Particularly, the tool 100 is formed from a first material 102 which may comprise stainless steel or some other commercially available material and the tool 100 includes a tangible item formation surface 104 and a void 106 which is communicatively coupled to the surface 104 and which includes copper material 108 or some other material which efficiently transfers heat. The tool 100 further includes a tube 110 which may be substantially filled with water or some other material 113 and which is communicatively coupled to the material 108 and which may also be coupled to a heat sink (e.g., a water reservoir), such as heat sink 23, which is remote from the tool 100. The tube 110 traverses through the width 111 of the tool 100. In this non-limiting embodiment of the invention, the tube 110 may be fixedly coupled to and within the tool 100 by material 108. Thus, it should be appreciated that the heat which is generated from the tangible item formation surface 104 is communicated to the material 113 and transported from the surface 104. Alternatively the need for tube 110 may be obviated by the use of conformal cooling passages as set forth in the U.S. patent application Ser. Nos. 10/440,454 (filed on May 16, 2003) and 10/308,602 (filed on Dec. 2, 2002) which are each fully and completely incorporated herein by reference, and such passages may have any desired shape or geometric orientation. The foregoing pending applications are owned by the assignee of these applicants.

In each of the foregoing embodiments, it should be appreciated that the tubes, such as tubes 22, 70, 110 may be substantially any size and geometric configuration and that :each of the tools 10, 50, 100 may respectively include several such tubes 22, 70, 110. In one non-limiting embodiment of the invention, the tubes, such as tubes 22, 70, 110 do not respectively traverse the tool 10, 50, 100 that they are respectively and operatively disposed within. In yet another non-limiting embodiment of the invention, a passageway may even be formed (e.g. drilled) through the material 30 which resides within the void 22.

It should further be appreciated that the tools 10, 50, 100 may be formed by substantially any sort of tool formation process (including a lamination process) and that the foregoing use of the material filled voids may eliminate the need for water cooling and substantially eliminates the potential or likelihood of water leakage and enhances thermal management since copper has a much greater conductivity than water and, as perhaps is more fully shown below, the copper filled or heat sink type voids, such as voids 18, 20, may be formed in substantially any desired location within the tools 10, 50, 100. By way of example and without limitation, the tool 10 may be formed by the selective creation and joining of sectional members, such as sectional members 101, 103 and the other tools 50, 100 may each further include respective sectional members. A review of one potential tool formation methodology will now ensure to allow one to more fully understand the overall tool formation process according to the teachings of the various inventions.

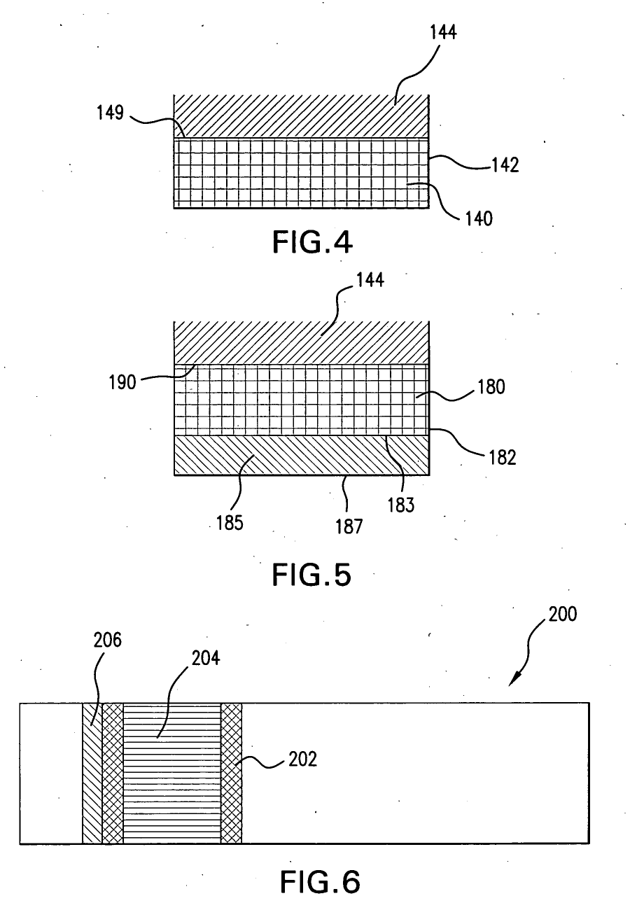

Referring now to FIG. 4, there is shown a pre-tool 140 being subjected to a certain process in order to produce one or more of the tools 10, 50, 100 which have been disclosed above. First, it should be appreciated that the pre-tool 140 may comprise a laminated pre-tool such as that which is referred to as tool 10 within U.S. Pat. No. 6,587,742 (hereinafter referred to as “The Patent”) which his fully and completely incorporated herein by reference and which is owned by the Assignee of these present Applicants. The term “pre-tool” as used in this description refers to a tool (such as a laminated tool) which has voids which do not presently contain copper or some other desired thermal management material.

Particularly, a void or passageway may easily be formed within a laminated pre-tool by having adjacent sectional members, such as sectional members 101, 103 have respectively and selectively aligned and registered indented portions 105, 107, which are perhaps best shown in FIG. 8. These aligned indented portions therefore cooperatively form an internal void or passageway, such as internal void or passageway 18, 20. Such a procedure may be used to form vertical type passageways such as passageways 18, 20. Other passages may also be formed, such as passageway 22, by the procedures set forth in the applications and the Patent which have been incorporated by reference.

Generally, the pre-tool 140 is placed within some sort of structure or an “open box” 142 and cooper or some other conductive material 144, such as copper, is placed in physical and/or communicative contact with the formed pre-tool 140. The pre-tool 140 and the material 144 are heated and the material 144 is made to flow within the various voids which are initially formed within the pre-tool 140, thereby substantially filling these formed voids,. such as voids 18, 20. After such voids are filled, the pre-tool 140 is allowed to cool and then is removed from the structure or box 142. Excess material 144 is removed from the top surface 149 of the pre-tool 140, thereby forming a tool, such as tool 10. The term “top surface” means, in this context, the surface which is in initial physical contact with the material 144 or which does not contact the box or container 142 and includes the surface upon which a tangible item is formed (e.g., the tangible item formation surface, such as surface 14).

To alleviate the need to “machine” or remove the excess material 144 from the top surface of the pre-tool 140, an alternative process or methodology may be utilized, as shown best in FIG. 5. Particularly, in this non-limiting embodiment, a void containing pre-tool 180 is placed within a container or “open box” 182 and the top surface 183 of the pre-tool 180 is made to contact some loose filler material 185 (e.g., casting sand or some other castable ceramic material having a melting point which is higher than that of copper or higher than that of the material used to fill the various tool voids) which is housed within the bottom surface 187 of the structure 182. The material 144 is placed upon the bottom surface 190 of the pre-tool 180 (e.g., surface 190 is opposite to top surface 183) and the apparatus is heated, effective to allow the material 144 to flow within the contained voids residing within the pre-tool 180, such as voids 18, 20. Advantageously, after the void filled pre-tool 180 is cooled, it may be removed from the container 182 and easily taken away from the filler material 185 without the need to clean the filler material from the top surface 183 For example, the melted copper substantially surrounds the pre-tool and enters the various voids through the gaps and passageways of the pre-tool. The pre-tool is then cooled and the previously infiltrated material is cooled, thereby fixedly residing within the pre-tool.

As shown best in FIG. 6, a tool 200 may even be formed having a void, such as void 202, having a plurality of materials, such as copper 206 and some sort of structurally strong material or some other material having desired properties, such as material 204.

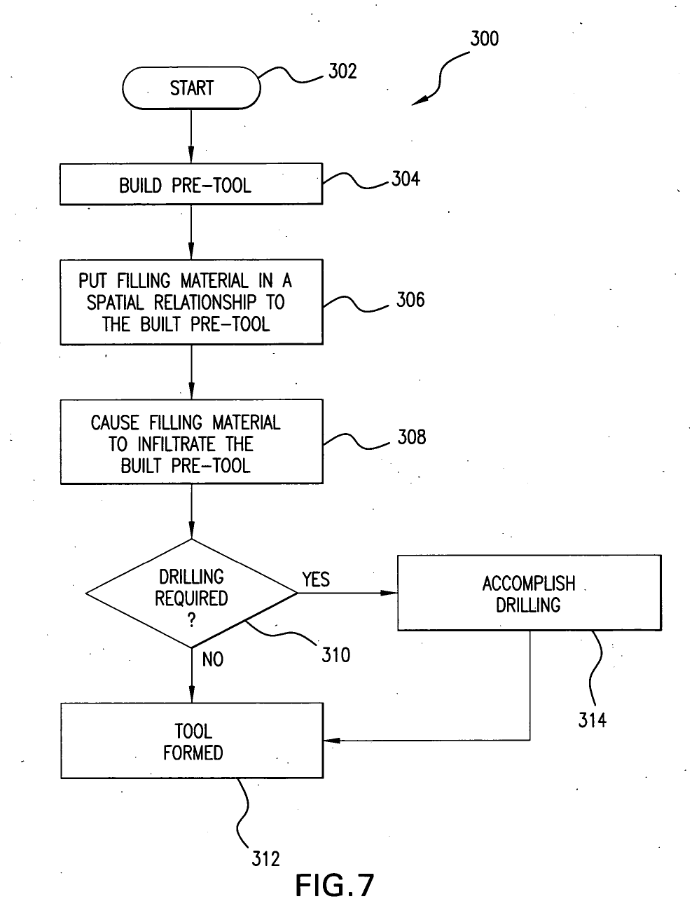

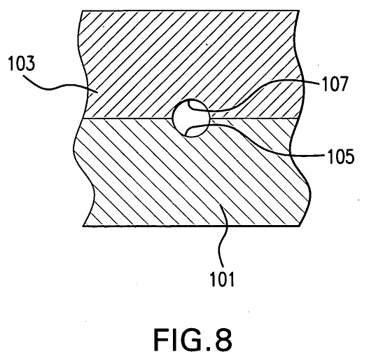

To more fully understand the tool creation methodology of the preferred embodiment of the invention, reference is now made to flowchart or methodology 300 which is shown in FIG. 7.

Particularly, the methodology 300 begins with an initial step 302 in which it is determined to build a tool, such as tool 10, 50, 100. The step 302 is followed by step 304 in which a pre-tool is built (a tangible creation/formation apparatus having unfilled voids or internal passageways). Non-limiting examples of built pre-tools include pre-tool 140.

Step 304 is followed by step 306 in which a filing material, such as copper, is placed in some sort of spatial relationship to the built pre-tool. Step 306 follows step 304 in which the filing material, such as copper material 30, is placed in a spatial relationship with the built pre-tool. Step 308 follows step 306 and, in this step 308, the filling material is caused to infiltrate the internal voids or passageways, such as by the use of heat. Step 310 follows step 308 and, in this step 310, it is determined whether drilling is required to be performed through a previously filled passageway or void. If no drilling is required, step 310 is followed by step 312 in which the tool is declared to have been completed. If drilling is required, step 310 is followed by step 314 in which the drilling is accomplished and then step 314 is followed by step 312.

It should be understood that the passageways and voids may be placed anywhere within the formed tool and that the foregoing strategy may be used to produce any desired tangible item having desired thermal management properties, including but not limited to tools. Further, the selectively infiltrated copper or other material reduces the need for the sectional members, in a laminated tooling strategy, to be accurate with respect to their intangible model counterparts (e.g., the infiltrated material “fills in gaps” between adjacent sectional members), thereby reducing the need for the feedback operation described within The Patent, thereby simplifying the overall lamination process. Relatively large tools may thereby be built in a cost effective manner.

It is to be understood that the invention is not limited to the exact construction or methodology which has been delineated above, but that various changes and modifications may be made without departing from the spirit and the scope of the inventions as are perhaps more fully delineated in the following claims. It should be appreciated that the tools 10, 50 and 100 may be made by any process and that any tangible item (not limited to tools) may have such a material infusion methodology applied to them to provide the foregoing thermal management benefits.

What is claimed is:

1) An item comprising at least one void which is substantially filled with a thermal management material and further having a surface which is created from a second material which is dissimilar to said thermal management material.

2) The item of claim 1 wherein said thermal management material comprises copper.

3) The item of claim 2 wherein said second material comprises aluminum.

4) The item of claim 3 wherein said surface comprises and entity forming surface.

5) The item of claim 1 wherein said thermal management material comprises an insalatine material.

6) The item of claim 3 wherein said surface is formed by the selective joinder of a first sectional member created from a first intangible partition and a second sectional member created from a second tangible partition and wherein said second intangible partition is formed by use of said first intangible partition.

7) A tool comprising a body including a forming surface, wherein said forming surface is created from a first material and wherein said body is formed from the selective joinder of a first and a second sectional member and wherein said body includes at least one void which is substantially filled with a thermal management material; and a tube which traverses said body and which is communicatively coupled to said thermal management material residing within said body.

8) The tool of claim 7 wherein said first material comprises stainless steel.

9) The tool of claim 7 wherein said thermal management material comprises copper.

10) The tool of claim 7 wherein said tube is welded to said body.

11) A method for making an item comprising the steps of forming a pre-item having at least one void; and placing a thermal management material within said void, thereby forming said item.

12) The method of claim 11 wherein said item comprises a tool.

13) The method of claim 12 wherein said thermal management material comprises copper.

14) The method of claim 13 wherein said pre-item is formed from stainless steel.

15) The method of claim 11 further comprising the steps or providing a tube; placing the tube within said pre-item; and coupling said tube to said thermal management material.

16) The method of claim 15 wherein said step of placing said tube within said pre-item comprises the step of welding said tube within said pre-item.

17) The method of claim 11 wherein said step of placing said thermal management material within said void comprises the step of providing thermal management material; placing said provided thermal management material on said pre-item; and heating said pre-item and said thermal management material, effective to allow said heated thermal management material to flow into said void; and cooling said pre-item and said thermal management material.
